(19) United States
(12) Patent Application Publication
(10) Pub. No.: US 2002/0046367 A1
(43) Pub. Date: Apr. 18, 2002

(54) Method for preventing data corruption by a floppy diskette controller

(76) Inventor: Jin-Hsin Yang, Peltou (TW)

Correspondence Address: RABIN & CHAMPAGNE, P.C., Suite 500, 1101 14th Street, N.W., Washington, DC, 20005, US

(21) Appl. No.: 09/976,063

(22) Filed: Oct. 15, 2001

(30) Foreign Application Priority Data
Oct. 17, 2000 (TW) 89121682

(51) Int. Cl. H04L 1/22

(52) U.S. Cl. 714/44

(57) ABSTRACT

A method for preventing data corruption in a Floppy Diskette Controller, which determines the potential for data loss and/or data corruption on the data transfer by determining if, before each data transfer byte is read out or written in the floppy diskette in DMA mode, the maximum delay time for DMA request (DREQ) from the issue to the removal is greater than a specific value, and initializing a specific process by the computer system according to the comparison result.

### BACKGROUND OF THE INVENTION

1. Field of the Invention

This invention relates to a method for preventing data corruption, and particularly to a method for preventing data corruption by a floppy diskette controller (FDC).

2. Description of the Related Art

In a computer system, a Floppy Diskette Controller (FDC) is used to control the data transfer (write or read data) to or from the FDC, and to interface the computer's Central Processing Unit (CPU) with the physical diskette device. The FDC has the ability to monitor a variety of operations during the data transfer to and from a floppy diskette. When an abnormality or an error appears during the data transfer, the FDC signals a warning to the computer system to respond to the abnormality. For example, data may be re-transferred. However, due to design flaws, the FDCs provided by some manufacturers can not detect errors in some specific situations.

Adams, for example, has described a situation in the U.S. Pat. No. 5,379,414 in which data loss and/or data corruption may routinely occur during data transfer to or from diskettes. Specifically, when the last data byte of a sector is transferred, if the last byte of a sector write operation is delayed too long, the next (physically adjacent) sector of the diskette will also be destroyed. In general, the FDCs can not detect such an error.

In the U.S. patent, Adams also describes a solution for the problem mentioned above. The solution adopts a software-based approach to measure the delay time for the last data byte transfer to a sector of the floppy diskette. When the delay time exceeds a predetermined time, a warning signal is sent to the computer system, so that the FDC or computer system can start the respective process (for example, re-transferring data) to minimize the damage from data loss and/or data corruption. It is noted that the delay time is the time between the data request (DREQ) and data acknowledgementment (DACK) signals of Direct Memory Access (DMA).

According to Adams' technique, only the last data byte is detected. However, all data in the transfer is probably lost and/or corrupted. For example, although the time delay does not happen on the last data byte transfer to a sector of the floppy diskette, all of the data is probably lost and/or corrupted due to the previous data write delay.

The data transfer between the personal computer and the FDC adopts DMA mode. When the data transfer is processed in DMA mode, a first-in first-out (FIFO) buffer device is used. During the data transfer of the FDC, the data is stored in the FIFO buffer device, such that the data is not normally lost and/or corrupted. However, Adams does not consider DMA mode with the FIFO buffer device.

As concerns DMA mode with the FIFO buffer device, according to Adams' technique, if the last byte of a sector write operation delay is detected, a warning is sent. The probability of the data loss and/or data corruption is small, however, due to the FIFO buffer device. Therefore, a mistake for operating the FDC appears when adopting Adams' technique. Further, if the warning is sent frequently, efficiency in the FDC access is dramatically reduced.

### SUMMARY OF THE INVENTION

Accordingly, an object of the invention is to provide a software control method for solving the problem of FDC-caused defects and detecting all possible error data in a computer system to reduce data loss and/or data corruption in write delay transfer to the FDC.

To realize the above and other objects, the invention provides a method for preventing the Floppy Diskette Controller (FDC) from causing data corruption in relation to the CPU, system interrupt clock, floppy disk, FDC and peripherals, the method as follows:

determining if a requested computer system operation accesses the data from an FDC;

measuring the time for DMA request (DREG) from the issue to the removal;

signaling an error from the computer system if the measured time exceeds a specific value.

The inventive method is accompanied by an interpose service routine pre-hooked to the interrupt vector, intercepted by the system interrupt clock and accompanied by the raised system interrupt clock rate during measurement of the time.

### BRIEF DESCRIPTION OF THE DRAWINGS

The aforementioned objects, features and advantages of this invention will become apparent by referring to the following detailed description of a preferred embodiment with reference to the accompanying drawings, wherein:

FIG. 1 shows a typical computer system's architecture;

FIG. 2 shows the timing of data transfer of FIG. 1 under DMA mode;

FIG. 3 shows an embodiment of the FDC method according to the invention;

FIG. 4a is a measurement flowchart of the maximum interval value with an interpose service routine; and

FIG. 4b is an extract flowchart of the result from FIG. 4a.

### DETAILED DESCRIPTION OF THE INVENTION

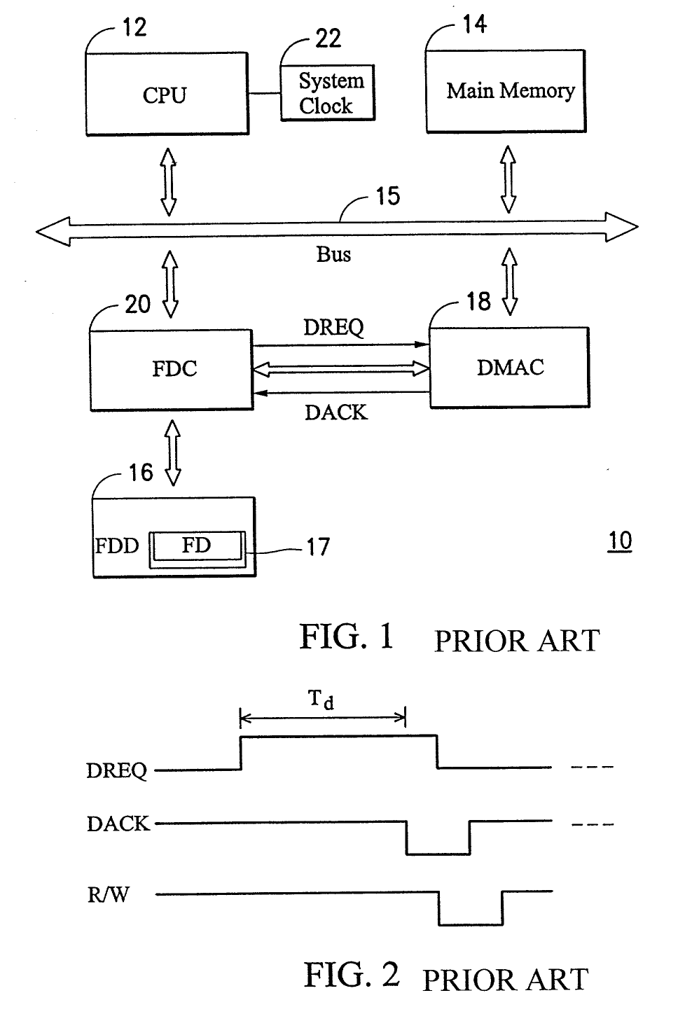

FIG. 1 shows a typical computer system's architecture. The computer system 10 has a central processing unit (CPU) 12 and a main memory 14 communicating with each other by a bus 15. During the duty cycle, the commands (e.g. an executable file, and so on) and data from the CPU 12 are stored in the main memory 14. The main memory 14 is capable of storing the data only during power-on, so a hard disk is added (not shown) to store the permanent data. Typically, a floppy disk drive 16 is essential equipment in a computer system like the system 10, in order to receive data from a removable floppy diskette 17.

In transferring data to the floppy diskette 17, the CPU 12 may program a DMA controller 18 for an input/output (I/O) transfer. The CPU 12 issues a command to a FDC 20 to begin the I/O transfer, and then waits for the FDC 20 to interrupt the CPU 12 with a completion interrupt signal.

The computer system 10 also has a system clock 22. For example, a timer 8253 is used as the system clock 22. The system clock 22 interrupts the CPU 12 at a rate of 18.2 times per second, i.e. roughly once every 54.9 ms.

DMA controller 18 manages data transfer between the FDC 20 and the main memory 14. A DMA request (DREQ) is issued to DMA controller 18 when the computer system 10 requests a data transfer (for example, a data write) to the floppy diskette 17 in DMA mode. Likewise, a DMA acknowledgement (DACK) is returned from DMA controller 18 to the FDC 20. Next, DMA request (DREQ) is removed. At this point, the computer system 10, for example, issues a read/write signal (R/W; not shown in FIG. 1) to write the data to the floppy diskette 17.

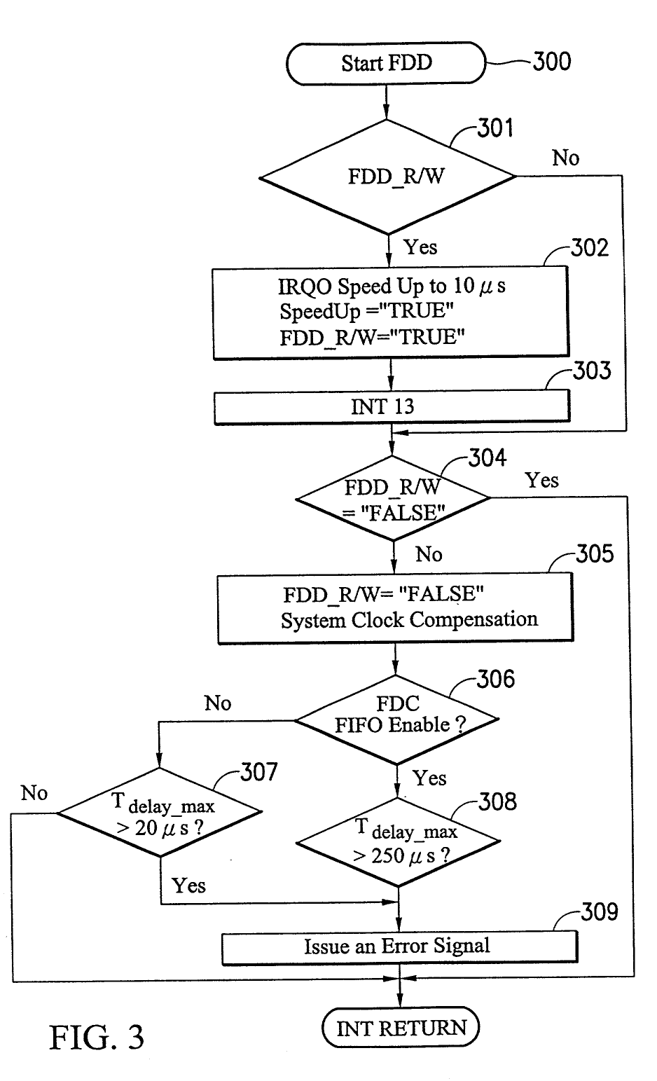

FIG. 2 shows the timing of the data transfer from FIG. 1 under DMA mode. When DMA request (DREQ) is issued, DMA request (DREQ) is changed from logic “0” to logic “1”. When DMA acknowledgement (DACK) is issued, DMA acknowledgement (DACK) is changed from logic “1” to logic “0”. When DMA request (DREQ) is removed, DMA request (DREQ) is changed from logic “1” to logic “0”.

In the mainboard of the computer system 10, DMA assignment preempts the FDC operations occurring on DMA channel 2 (which is lower priority than other DMA channels). Hence, while the floppy diskette 17 transfer is active in DMA mode, if the computer system 10 is busy for the concurrent transfer of data to or from a network, the delay time T_{d} from DMA request (DREQ) issued to DMA acknowledgement (DACK) returned is long to incur the data delay read from/write into the floppy diskette 17. In some I/O chips, the highest potential for data loss and/or data corruption is present when the delay time T_{d} ranges from about 20 μs to about 30 μs. If a FIFO buffer device (not shown) is implemented in and enabled by the FDC 20 or DMA controller 18, the highest potential for data loss and/or data corruption is present when the delay time T_{d} exceeds about 250 μs due to the temporary storage feature of the FIFO buffer device.

Accordingly, the length of delay time T_{d} is an important indicator to determine if the read/write data is lost or corrupted for every byte of data transfer in DMA mode.

According to the Adams technique, only the last data byte of the DMA transfer is detected. The delay time T_{d} is measured before the last data byte is written to the floppy diskette 17 to determine if the time T_{d} exceeds a specific value, thereby determining the potential for data loss and/or corruption. obviously, since the delay time T_{d} exceeding a specific value happens on the previous data byte (not the last data byte) from or to the floppy diskette 17, Adams' technique can neither handle it nor signal the system to respond to it. Also, if the FIFO buffer device in the DMA controller is enabled, the tolerance of the delay time T_{d} can become longer (e.g. from 20 μs to 250 μs). However, the FIFO buffer device in DMA controller is not considered in the Adams' technique, this means that a normal transfer (i.e. 20 μs<T_{d} <250 μs) may be determined as a data loss and/or data corruption so as to have an unnecessary response (for example, to transfer data again)from the system. The operating performance of the floppy diskette 17 and computer system is therefore reduced.

Accordingly, the invention provides a method for preventing floppy diskette controller data transfer errors, comprising the following steps:

(a) determining if a requested computer system operation is a floppy diskette operation;

(b) hooking an interpose service routine to provide the interrupt vector intercepted by an interrupt clock of the system;

(c) programming the system interrupt clock to interrupt faster than normal, wherein DMA request (DREQ) is detected for every interrupt issued by the system interrupt clock;

(d) initiating the floppy diskette service routine of the computer system to access the data in the floppy diskette;

(e) measuring the time interval for every DMA request (DREQ) from the issue to the removal and recording the maximum time interval value;

(f) if the maximum time interval value exceeds a specific value, the computer system issues a warning signal;

(g)reprogramming the system interrupt clock to interrupt normally.

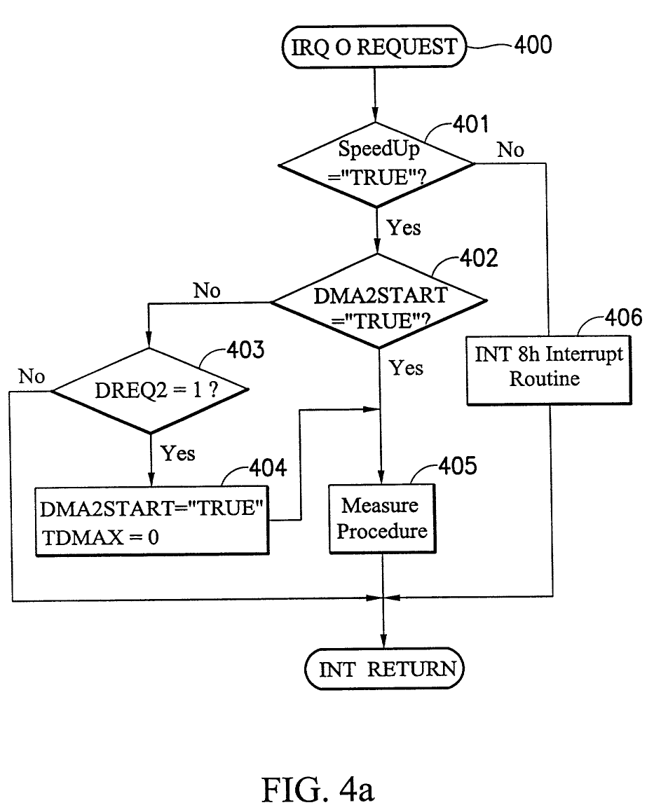

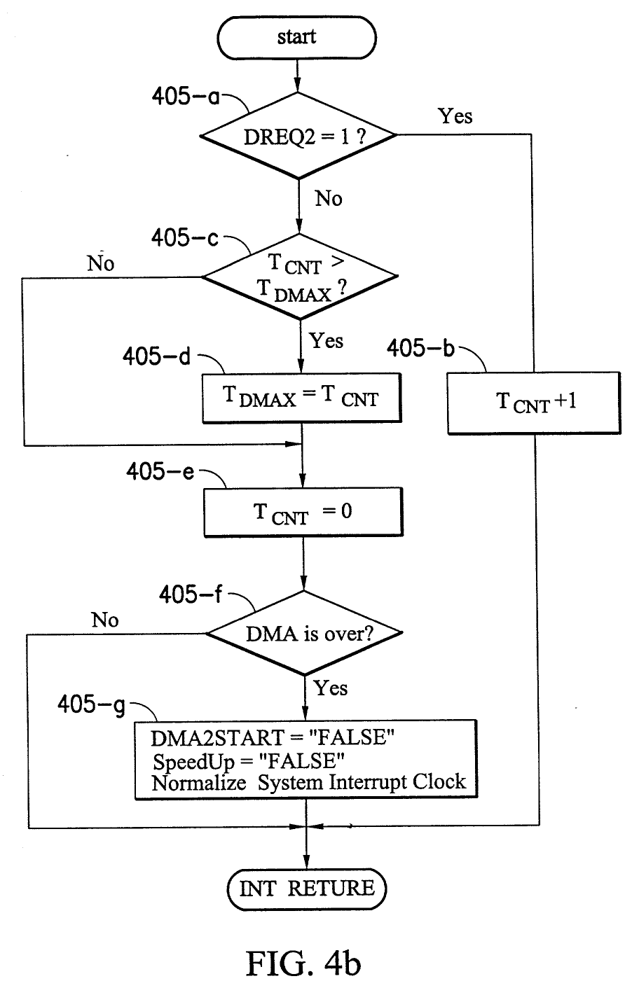

The invention is described in detail as follows with reference to FIG. 3 and 4.

In general, INTEL and its compatible CPU can provide at least 256 interrupts, each having a specific usage. The interrupts corresponding to the invention are simply described as follows.

INT 13h is Floppy Diskette I/O service routine.

INT 8h is a hardware interrupt with the system clock or system interrupt clock continually interrupting every 54.9 microsecond, i.e. a frequency of 18.2 times/sec. In the interrupt routine of INT 8h, a designer can define or hook an interpose service routine desired in order to perform the motion defined by the interpose service routine when INT 8h is issued (that is, INT 8h is intercepted by the system clock).

In step (b) mentioned above, in the embodiment, the invention intercepts INT 8h directly due to the speed consideration. The interpose procedure as shown in FIG. 4 is described in detail as follows.

FIG. 3 shows a of an embodiment of the FDC method according to the invention.

As shown in FIG. 3, when the computer system 10 starts floppy diskette driver access through the operating system (step 300) to access data.

In this embodiment, the floppy diskette driver introduces some complementary programs into the conventional floppy diskette service routine (step 303) to complete the control flow required by the embodiment.

Firstly, determine if the computer system 10 accesses the data to the floppy diskette 17 after starting the floppy diskette driver (step 301).

If the data access action is determined in step 301, (step 302) request the interrupt service of INT 8h to the computer system through the interrupt request IRQ 0 in order to re-define the system interrupt clock (or system clock) 22. The re-defined system clock 22 interrupts at an accelerated rate of 10 microseconds, faster than the normal interrupt rate of 54.9 milliseconds. Also, the accelerated flag SpeedUp is set to “TRUE” and the floppy diskette R/W flag FDD_R/W is set to “TRUE”.

Secondly, perform a conventional floppy diskette service routine (step 303). The central application configuration calls the respective function of the floppy diskette I/O service routine INT 13. Meanwhile, if a DMA transfer is requested, the flag DMA2START of DMA channel 2 is set to “TRUE” (the system generally adopts the function of DMA channel 2 of DMA mode when accessing data from floppy diskette).

While step 303 is in progress, the system interrupt clock remains at the rate of 10 microseconds. DMA request (DREQ) is detected for every interrupt. That is, in this embodiment, the time interval value from the request issued (DREQ2=1) to the request removed (DREQ2=0) is detected and the maximum delay time T_{delay}_{_{—}}ₘₐₓ therebetween is recorded.

The system interrupt clock 22 returns to the normal interrupt rate after the data transfer is completed (step 303 over). Step 304 determines if the floppy diskette service routine in step 303 has floppy diskette access (i.e. the floppy diskette R/W flag FDD_R/W=“TRUE” is determined). If FDD_R/W=“TRUE”, step 305 is performed. In step 305, the flag FDD_R/W is reset to “FALSE” and the respective complement of the system time (for the delay time) is performed.

In step 306, detect if a FIFO buffer device exists in the FDC 20 or DMA controller 18 is and enabled. If not, the computer system 10 issues an error signal when the maximum delay time T_{delay}_{_{—}}ₘₐₓ greater than a first specific value (e.g. 20 microseconds) appears (step 309). If yes, the computer system 10 issues an error signal when the maximum delay time T_{delay}_{_{—}}ₘₐₓ is greater than a second specific value (e.g. 250 microseconds) appears (step 309).

Referring to FIG. 3 again, after the computer system engages the floppy diskette driver (step 300), the computer system 10 directly performs the conventional floppy diskette service routine (step 303) to complete the data transfer if the computer system 10 is not engaged in floppy diskette 17 access (rather, accessing the hard disk or other storage).

FIGS. 4a and 4b show a measurement flowchart of the maximum delay time T_{delay}_{_{—}}ₘₐₓ.

The pre-defined interpose service routine (hereinafter, referred to as an interpose procedure) is performed by every request from the computer system 10 for the interrupt service of INT 8h through the signal IRQ 0. First, as the flag SpeedUp “TRUE” is determined by the interpose procedure (step 401), the computer system 10 on the floppy diskette 17 is determined. Otherwise, the conventional interrupt routine of INT 8h is performed (step 406).

Sequentially, if the flag DMA2START of DMA channel 2 is determined not to be set as the logic “TRUE” (step 402), it determines if the flag DREQ2 of DMA request (DREQ) is “1” (step 403). If the logic of DREQ2 is not “1”, it signifies that the computer system 10 cannot start data access to the floppy diskette 17 in DMA mode. If the logic “1” of DREQ2 is determined (step 403), step 404 is performed. In step 404, the flag DMA2START is set to “TRUE” and a maximum interval value TD_{MAX} is set to 0.

Sequentially, a measurement procedure is performed (step 405) to measure an interval count T_{CNT} (or the sampling point)of every foregoing DMA request from the issue to the removal before every byte of data is accessed in DMA mode. Therefore, a maximum delay time T_{delay}_{_{—}}ₘₐₓ is obtained as DMA transfer is over. The flags DMA2START and SpeedUp are reset to “FALSE”. The system interrupt clock is returned to the normal rate.

Referring to FIG. 4b, in the foregoing measurement procedure (step 405), determine if the flag DREQ2 of DMA request (DREQ) is “1” (step 405-a). If DREQ2=1, the count T_{CNT} is increased by 1 (step 405-b), returning back to the operating system. Next, step 405-a is repeated at the rate of 10 microseconds. The count T_{CNT} is continuously increased by 1 (step 405-b) if DMA request (DREQ) is on the issued state (DREQ2=1).

Once DMA acknowledgement (DACK) is issued, the DMA request (DREQ) is removed (DREQ2=0). It is determined if T_{CNT}>TD_{MAX} as DREQ2=0 (step 405-c). When T_{CNT}>TD_{MAX}, TD_{MAX}=T_{CNT} (step 405-d); otherwise, TD_{MAX} remains unchanged and T_{CNT=}0 (step 405-e) such that DREQ2 can measure the time with respect to the state of DREQ2=1 before another byte is accessed by the DMA mode.

The maximum interval TD_{MAX} obtained after step 405-e is completed is a maximum delay time T_{delay}_{_{—}}ₘₐₓ (=TD_{MAX}X 10 microseconds) of DMA request (DREQ) from the issue to the removal.

Step 405-f is to detect if DMA transfer is over. If not, step 405 repeats and re-accumulates the count T_{CNT} in order to find the interval TD_{MAX} when DMA transfer is over.

When DMA transfer is over, step 405-g is performed in order to reset the flags DMA2START and SpeedUp into “FALSE”; and recovers the system interrupt clock to an interrupt rate of the normal IRQ 0.

The maximum delay time T_{delay}_{_{—}}ₘₐₓ (i.e. a read or write delay) of DMA request (DREQ) from the issue to the removal before each byte is read out or written in the floppy diskette with DMA mode is found through the maximum interval TD_{MAX} obtained from the execution of FIG. 3, 4a and 4b. Therefore, the potential for data loss and/or data corruption in the data transfer is determined by determining if the maximum delay time T_{delay}_{_{—}}ₘₐₓ is greater than a specific value (e.g. 20 microseconds or 150 microseconds with FIFO), thereby performing a specific process by the computer system according to the comparison result.

The inventive application carries distinct advantages as follows:

It is capable of detecting all possible error data;

It provides more efficient transfer performance due to the FIFO;

In mainboard or system manufacture, it ensures mainboard quality and protects users from data loss and/or data corruption by detecting all possible FDC defection in advance;

For a defective FDC after the commerce, the user can eliminate the defect by modifying the driver or BIOS with the inventive method thus protecting the user from data loss and/or data corruption.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for preventing data corruption in a Floppy Diskette Controller, applied to a computer system having: a central processing unit; a system interrupt clock; a floppy diskette; a floppy diskette controller for controlling the data transfer to the floppy diskette; peripherals associated with the floppy diskette controller for providing a DMA request (DREQ) and a DMA acknowledgement (DACK), the DREQ being issued when data transfer is requested by the computer system and the DACK being issued when data transfer is permitted;
the method comprising the steps of:
determining if a requested computer system operation accesses the data from a FDC;
measuring the time for DMA request (DREG) from the issue to the removal; and
signaling an error from the computer system if the measured time exceeds a specific value.

2. The method of claim 1, further comprising the steps of:
pre-hooking an interpose service routine to an interrupt vector intercepted by the system interrupt clock;
increasing the interrupt rate provided by the system interrupt clock, wherein the measured time is performed through the interpose service routine for every interrupt; and
recovering the system interrupt clock to interrupt normally after the floppy diskette data transfer is completed and unhooking the interrupt vector.

3. A method for preventing data corruption in a Floppy Diskette Controller, applied to a computer system having: a central processing unit; a system interrupt clock; a floppy diskette; a floppy diskette controller for controlling the data transfer to the floppy diskette; peripherals associated with the floppy diskette controller for providing a DMA request (DREQ) and a DMA acknowledgement (DACK), the DREQ being issued when data transfer is requested and the DACK being issued when data transfer is permitted;
the method comprising the steps of:
determining if a requested computer system operation accesses the data from a FDC;
programming the system interrupt clock to increase the interrupt rate provided by the system interrupt clock, wherein the existence of DMA request (DREQ) is detected for every interrupt issued by the system interrupt clock;
calling the floppy diskette service routine of the computer system so as to access the data from the floppy diskette;
measuring the time for DMA request (DREG) from the issue to the removal and recording the maximum time;
signaling an error from the computer system if the measured time exceeds a specific value; and
reprogramming the system interrupt clock to recover the interrupt at a normal rate.
